(19) United States
(12) Patent Application Publication
(10) Pub. No.: US 2015/0099552 A1
(43) Pub. Date: Apr. 9, 2015

(54) System and Method for Locating a Vehicle

(71) Applicant: Innova Electronics, Inc., Irvine, CA (US)

(72) Inventor: Ieon C. Chen, Laguna Hills, CA (US)

(73) Assignee: Innova Electronics, Inc., Irvine, CA (US)

(21) Appl. No.: 14/049,982

(22) Filed: Oct. 9, 2013

(51) Int. Cl. H04W 4/02

(52) U.S. Cl. CPC H04W 4/028
USPC 455/457

(57) ABSTRACT

A system for locating a vehicle using a monitoring device attachable to a vehicle and a mobile device. The monitoring device plugs into a vehicle diagnostic port and transmits an indicator signal to the mobile device, such as a smart phone, when the vehicle's engine is shut down. Upon receipt of the indicator signal, the mobile device determines its current location and saves it as the vehicle's location. The vehicle's location may then be displayed to the user on the mobile device. Such a system may be used with any vehicle, and allows for vehicle location without requiring that the vehicle have its own location system, such as a GPS system. The user's location may also be determined on the mobile device, along with directional information for guiding the user to their vehicle.

### CROSS-REFERENCE TO RELATED APPLICATIONS

Not applicable

### STATEMENT RE: FEDERALLY SPONSORED RESEARCH/DEVELOPMENT

Not applicable

### BACKGROUND

1. Technical Field

The present disclosure relates generally to vehicle location systems. More particularly, the present disclosure relates to a system for automatically storing the location of a vehicle on a mobile communication device for later retrieval and guidance of the user to the vehicle.

2. Related Art

The need to locate a vehicle arises in many different contexts. A vehicle owner or user may have difficulty locating a vehicle in a large parking lot or in an unfamiliar neighborhood. People attending concerts, sporting events, and other activities can experience difficulties remembering where their car was parked. Automobile dealerships, towing operators, and other businesses can also have difficulty identifying the location of a particular vehicle in their inventory.

A variety of different devices and techniques have been proposed to address these problems. In many cases those systems include the use of a handheld device which interacts with a vehicle mounted GPS device to identify the location of where the vehicle is parked. In some cases the handheld device will derive directions to the parking location by comparing the stored vehicle location with the current location of the user.

While handheld devices, such as smart phones or other devices, can be manually operated to store the location of the vehicle parking location, users may neglect to manually input the location where they have parked the vehicle, particularly when they anticipate that they won't be travelling far from the vehicle, and/or will be returning soon. This may also be the case where the user is getting in and out of the vehicle frequently, may be carrying objects that might make the operation of the handheld device inconvenient, or may be distracted.

In order to avoid the requirement that the user manually input the parking location, some have suggested systems where the vehicle GPS system may periodically transmit location information to the handheld device until the vehicle is parked and the engine is turned off. The last transmitted position is then deemed to be a reasonable estimate to where the vehicle is parked and/or located.

One shortcoming of such prior systems concerns the need to adapt the vehicles to interface with the handheld device. Such systems are likely to be only useable where a specific vehicle and handheld device combination is used, and becomes ineffective when the user operates a different vehicle, or the vehicle is operated by a different user having a different handheld device.

An additional shortcoming is that such a system requires that a vehicle be used which has a GPS system installed. This may preclude use of such systems with vehicles which pre-date the introduction of GPS technology, or may require a user to purchase an aftermarket GPS system.

It is, therefore desirable to provide a vehicle locator system and methodology which does not require a vehicle GPS system, or use of a specifically modified vehicle which has been made compatible with a specific handheld device. This allows for a broader application of the present invention in relation to most, if not all, vehicles in an unmodified condition.

It is also desirable to provide a vehicle locator system and methodology that allows the user to locate any vehicle that the user has been driving by using a single handheld device.

These and other advantages are implemented in the present invention, as described in further detail below.

### BRIEF SUMMARY

To solve these and other problems, a system for locating a stationary vehicle is contemplated which utilizes a monitoring device and mobile communication device. The monitoring device is operatively connectable to the vehicle and has a monitoring circuit for detecting when a vehicle engine is turned off, and for generating an indicator signal in response. The monitoring device also has a wireless communication circuit for wirelessly transmitting the indicator signal to the mobile communication device.

The mobile communication device has a first receiver, a second receiver, a location data processor in communication with the first and second receivers, and a display module in communication with the location data processor. The first receiver is for receiving location data corresponding to the position of the mobile communication device, and the second receiver is for receiving the indicator signal from the monitoring device. In one embodiment the first and second receivers may be implemented as a single common receiver.

When the location data processor detects that the indicator signal has been received on the second receiver, the location data processor receives and stores the first location data that is received on the first receiver. As such, the first location data that is received on the first receiver at the time the indicator signal is received on the second receiver is representative of a first vehicle location. The display module, which is in communication with the location data processor, is operative to display a representation of the first vehicle location.

The mobile communication device can be, for example, a cellular telephone. Additionally, the mobile communication device may have an input module in communication with the location data processor. The input module can generate a vehicle location query user input signal, which may result in the display module displaying a representation of the first vehicle location.

It is further contemplated that the mobile communication device, in response to receiving the vehicle location query user input signal, can receive and store on the location data processor a second location data that is received on the first receiver. The second location data, being received substantially simultaneously with the receipt of the vehicle location query user input signal, is representative of a user location. The display module will then be operative to display the user location and the first vehicle location, and can operate to display directional information between the user location and the first vehicle location.

The monitoring circuit of the monitoring device can be configured to only generate the indicator signal under certain circumstances, such as when it detects that the vehicle engine is turned off in combination with another vehicle status indication, for example, a vehicle door status indication. The monitoring device may also monitor or receive other information from the vehicle, such as vehicle identifying or status information, and may communicate such information to the mobile communication device. The vehicle identifying information can be, for example, a VIN number or a ticket number, where the invention is used to support valet parking services. The display module of the mobile communication device can, in certain embodiments, display the vehicle identification, status information or ticket number in addition to the vehicle location.

It is contemplated that the first receiver of the mobile communication device is adapted to function as a global position system (GPS) receiver, and the location data received on the first receiver is GPS data. Additionally, it is envisioned that the wireless communication circuit of the monitoring device is a local transmitter, and the second receiver of the mobile communication device is a local receiver. The monitoring device, in one preferred embodiment, may be a dongle or adaptor housing a communication circuit and including a connector port, the connector port being operatively connectable to the vehicle via a vehicle diagnostic port.

It is also contemplated that the invention, or a portion thereof, may be embodied by an article of manufacture comprising a non-transitory computer readable medium readable by a data processing apparatus including a memory and an output device, the medium tangibly embodying one or more programs of instructions executable by the data processing apparatus to perform a method of locating a stationary vehicle. In such an embodiment, the data processing apparatus receives an indicator signal generated in response to a user input shutting down a vehicle engine, and substantially simultaneously receives a first location data corresponding to a first vehicle location. The first location data is stored on the memory. When a vehicle location query user input signal is received on the data processing apparatus, the first location data is retrieved from the memory, and a representation of the first vehicle location may be generated on the output device.

The data processing apparatus may be useful to implement a method comprising the step of receiving a second location data corresponding to a user location in response to receipt on the data processing apparatus of the vehicle location query user input signal. Thus, the output of the output device can include, in addition to a representation of the vehicle location, a representation of the user location. In this case, the data processing apparatus may be configured to derive directional information between the user location and the first vehicle location, and such directional information may be generated on the output device as well. The location data in this exemplary embodiment is contemplated to be GPS data, the data processing apparatus is contemplated to be a cellular telephone, and the representations on the output device are contemplated to include a map. In this exemplary embodiment, the representation of the first vehicle location on the output device may be generated by interfacing with a mapping module, such as a map software.

It is further contemplated that the invention may be embodied in a method for locating a stationary vehicle with a mobile communications device having a memory. Such a method comprises the steps of receiving on the mobile communication device an indicator signal generated in response to a user input shutting down a vehicle engine, receiving on the mobile communication device a first location data corresponding to a first vehicle location, storing on the memory of the mobile communication device the first location data, receiving on the mobile communication device a vehicle location query user input signal, retrieving from the memory the first location data in response to receipt of the vehicle location query user input signal, and generating on the mobile communication device a representation of the first vehicle location.

Such a method may, in certain embodiments, include the step of receiving on the mobile communication device a second location data corresponding to a user location in response to receipt on the mobile communication device of the vehicle location query user input signal. The second location data corresponds to the user's location, as it is received on the mobile communication device substantially simultaneously with the receipt of the vehicle location query user input signal. In this case, the generating step can further comprise generating a representation of the user location. Directional information may also be generated for travel between the user location and the vehicle location.

### BRIEF DESCRIPTION OF THE DRAWINGS

These and other features and advantages of the various embodiments disclosed herein will be better understood with respect to the following description and drawings, in which:

FIG. 1 is a perspective view of a vehicle, a user with a mobile communication device, and a GPS network;

FIG. 2 is a block diagram showing the interconnections between components of the system;

FIG. 3 is a block diagram showing the interconnection between components of the monitoring device;

FIG. 4 is a block diagram showing the interconnection between components of the mobile communication device;

FIG. 5 is a front view of an input module of a mobile communication device; and

FIG. 6 is a front view of a display module displaying a representation of a vehicle location and a user location.

Common reference numerals are used throughout the drawings and the detailed description to indicate the same elements.

### DETAILED DESCRIPTION

According to various aspects of the present invention, a system, article of manufacture, and associated method are contemplated wherein a user may utilize a mobile communication device, such as a cellular telephone, in combination with a monitoring device on a vehicle, to automatically determine and store the vehicle's location on the mobile communication device, and allow the user to later retrieve that location on the mobile communication device, so as to aid in locating the vehicle. In an exemplary embodiment of one aspect, the monitoring device is a plug-in device attachable to a vehicle diagnostic port, which transmits an indicator signal when the vehicle's engine is shut off. The mobile communication device, which in the exemplary embodiment is the user's cellular telephone, receives the indicator signal, prompting the communication device to determine and store its current location as the vehicle's location. When the user desires to locate their vehicle, they query the communications device to retrieve the stored vehicle location, of which a representation is displayed on an output device of the communications device, such as the screen of a cellular telephone. The communication device may also query its current location, so as to derive and display directional information between the user's location and the vehicle's location.

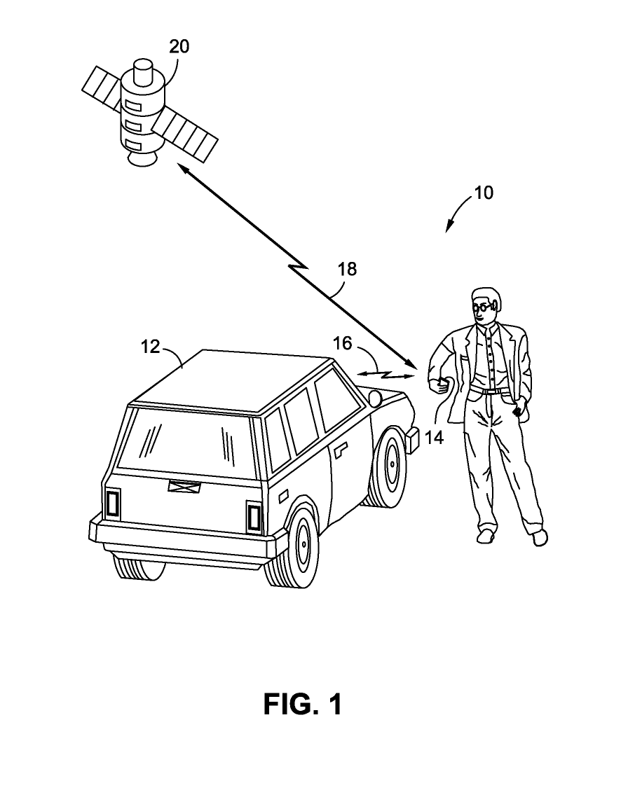

Referring now to the drawings, and more specifically to FIG. 1, an illustration of the system for vehicle location 10 is shown. According to this particular embodiment, when a user turns off the engine of their vehicle 12, the mobile communication device 14 receives an indicator signal 16. The receipt of the indicator signal 16 prompts the mobile communication device 14 to determine the mobile communication device 14's current location, which may be achieved by receiving a first location data 18 from a location data provider 20, such as a GPS satellite.

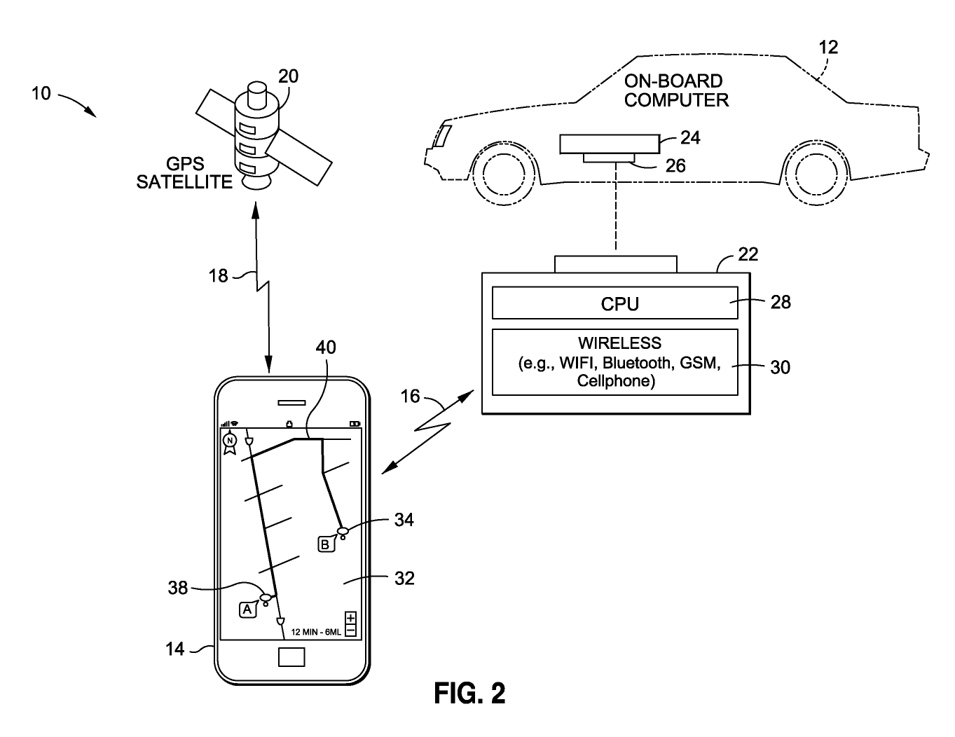

Referring now to FIG. 2, a more detailed block diagram of the system for vehicle location 10 is shown. In this exemplary embodiment, the monitoring device 22 may be seen to interface with the on-board computer 24 of the vehicle 12. In an exemplary embodiment, the monitoring device 12 is a plug-in device attachable to a vehicle diagnostic port 26. However, it may be seen that in other embodiments, the monitoring device 22 may be attachable to the vehicle in other ways, or may be a more permanent component of the vehicle integrated with the on-board computer 24. When the monitoring circuit 28 of the monitoring device 22 detects that the vehicle 12 has had its engine shut down, the monitoring circuit 28, which in an exemplary embodiment includes the CPU of the monitoring device 22, generates an indicator signal 16. The indicator signal 16 is then transmitted by a wireless communication circuit 30.

It is contemplated that the monitoring device 22 may be a separate component from the vehicle 12 or fully integrated with the vehicle 12. The monitoring device 22 may communicate with the vehicle's on-board computer 24 or another vehicle component to detect when the engine is turned off. Such communication may be in any fashion in which devices communicate, including but not limited to wired electronic communication, wireless communication, or mechanical linkage. In the exemplary embodiment, the monitoring device 22 may be plugged into a vehicle diagnostic port 26, so that the monitoring device 22 may be capable of being used with many different makes and models of a vehicle 12. This is because a vehicle diagnostic port 26 generally is a common feature in many if not all vehicles 12 manufactured and in use today, and vehicle diagnostic ports 26 are generally manufactured with a common standardization. Since 1996, the OBD-II standard is the typical vehicle diagnostic port 26 interface on vehicles manufactured in the United States and worldwide. Other vehicle diagnostic port 26 standards also exist, primarily on pre-1996 models, or may exist in the future, and it may be seen that the monitoring device 22 may be manufactured to be compatible with such vehicle diagnostic ports 26 as well, or may be made compatible with such vehicle diagnostic ports 26 through the use of adapters or other equipment.

The monitoring circuit 28 may be, in one exemplary embodiment, a central processing unit (CPU) housed within the monitoring device 22. However, it may be seen that the monitoring circuit 28 may be any circuit capable of detecting when a vehicle engine has been turned off and generating an indicator signal 16 in response thereto to be transmitted by a wireless communication circuit 30. It may be seen that in other embodiments, the monitoring circuit 28 may be, for example but without limitation, integrated with the vehicle on-board computer 24 or be embodied by the vehicle on-board computer 24 which may perform the function of generating the indicator signal 16 to be transmitted.

The wireless communication circuit 30 may be, for example but without limitation, a local transmitter such as a Wi-Fi or Bluetooth transmitter, or a long-range transmitter such as a radio transmitter. In one exemplary embodiment, the wireless communication circuit 30 is a Bluetooth transmitter. However, it may be seen that any wireless transmitter may be used which may convey the indicator signal 16 from the wireless communication circuit 30 of the monitoring device 22 to the mobile communication device 14. In one exemplary embodiment, it is contemplated that such conveyance of the indicator signal 16 will occur over a very short distance, as the mobile communication device 14 is a cellular telephone carried on or near to the user, typically the driver or a passenger in the vehicle 12, and the indicator signal 16 will usually be sent when the user is still within or in close proximity to the vehicle 12 which has just had its engine shut off.

The indicator signal 16 may, in some embodiments, include or be accompanied by the transmission of additional vehicle information. For example, a VIN number or make and model information may be read from the vehicle on-board computer 24 by the monitoring device 22 and transmitted to the mobile communication device 14 to allow for more accurate identification of a vehicle 12. Such an embodiment may find utility when a user may desire to store the locations of multiple vehicles simultaneously, or to store the location of vehicles for which that user's possession is only transitory, such as by valet services or vehicle renters. Further, vehicle status indications may be conveyed, such as window or door open status indications. It may also be seen that generation of the indicator signal 16 need not be limited to vehicle states in which only the engine is shut off. For example, additional embodiments are contemplated in which an indicator signal 16 is not generated until both the vehicle engine is shut off and a door being opened is detected by the monitoring circuit 28 of the monitoring device 22. This may have the advantage of preventing unwanted transmission of the indicator signal 16 when a vehicle is only temporarily stationary. Other embodiments may include mechanisms to override the sending of an indicator signal 16. For example, a vehicle 12 may occasionally need to be stationary with its engine off to be refueled, so a particular embodiment may be configured to not transmit an indicator signal 16 if the gas tank cover is open when the engine is turned off and a door is open. Preferably, the monitoring device 22 may be configured to send an override signal upon engine of the vehicle engine, which may cause the mobile communication device 14 to clear a first location data 18.

The mobile communication device 14, in the exemplary embodiment, is a cellular telephone having a display module 32. However, it may be seen that the mobile communication device 14 may be any device capable of receiving indicator signal 16, receiving and storing location data 18 at the time of receipt of the indicator signal 16 as a vehicle location 34, and displaying a representation of the vehicle location 34 on a display module 32. One exemplary embodiment contemplates that the cellular telephone has a display module 32 that is a graphical display, such as those found on smart phones with mobile operating systems. Preferably, the display module 32 may display the representation of the vehicle location 34 as a point on a map, such as a software-generated map on a smart phone with a mobile operating system. However, it may also be seen that other devices may be used as the mobile communication device 14, including cellular telephones without mobile operating systems, devices in which vehicle location may be their primary function, or devices in which the display module 32 is not a graphical display, but may be for example a numerical display for displaying other indicia such as geographical coordinates or parking stall numbers corresponding to the determined vehicle location 34.

In one exemplary embodiment, the mobile communication device 14 may receive a vehicle location query user input signal 36, and in response thereto, display the representation of the vehicle location 34 on the display module 32. Such a feature may be useful, for example, when the mobile communication device 14 is a multi-functional device such as a cellular telephone, wherein the storage and retrieval of the location of a vehicle 12 may be one of a multitude of functions able to be performed. But it may also be seen that such a feature may be useful when, for example, the mobile communication device 14 may have a limited battery life or other durational or preferential constraints, in which the representation of the vehicle location 34 may be preferred to be displayed only when a user desires to cause the vehicle location query user input signal 36 to be received on the mobile communication device 14. It is contemplated that in some preferred embodiments, the vehicle location query user input signal 36 is caused to be received by the user pressing a button on the mobile communication device 14.

Receipt of the vehicle location query user input signal 36 may be associated with the determination and display of a user location 38. Such a determination is, in the exemplary embodiment, performed by the mobile communication device 14 receiving and storing location data 18 from a location data provider 20 at the time of the receipt on the mobile communication device 14 of the vehicle location query user input signal 36. The location data 18 received and stored at this time, given that the user is in physical possession of the mobile communication device 14, corresponds to a user location 38, of which a representation may be displayed on the display module 32. Consequently, it may be seen that directional information 40 may be derived between the user location 38 and the vehicle location 34, and such directional information 40 may be conveyed to the user on the display module 32. In one exemplary embodiment, the directional information 40 may be displayed on the on the display module 32 of a smartphone in the form of a displayed path or a series of instructions. For example, many smart phones with mobile operating systems have map software which may generate directional information 40 between inputted locations, and it is contemplated that the generation of directional information 40 may occur through interfacing with such a map software and providing the vehicle location 34 and the user location 38 as the inputted locations.

Location data 18 received from a location data provider 20 is, in one exemplary embodiment, GPS data received from a network of GPS satellites. However it may also be seen that location data 18 may be received and determined in any way in which locations are remotely receivable and determinable. Such alternate ways of determining location data 18 may include, for example but without limitation, multilateration or triangulation of radio signals between radio towers of a cellular network, GSM localization based on signal strength, or crowd-sourced Wi-Fi positioning systems.

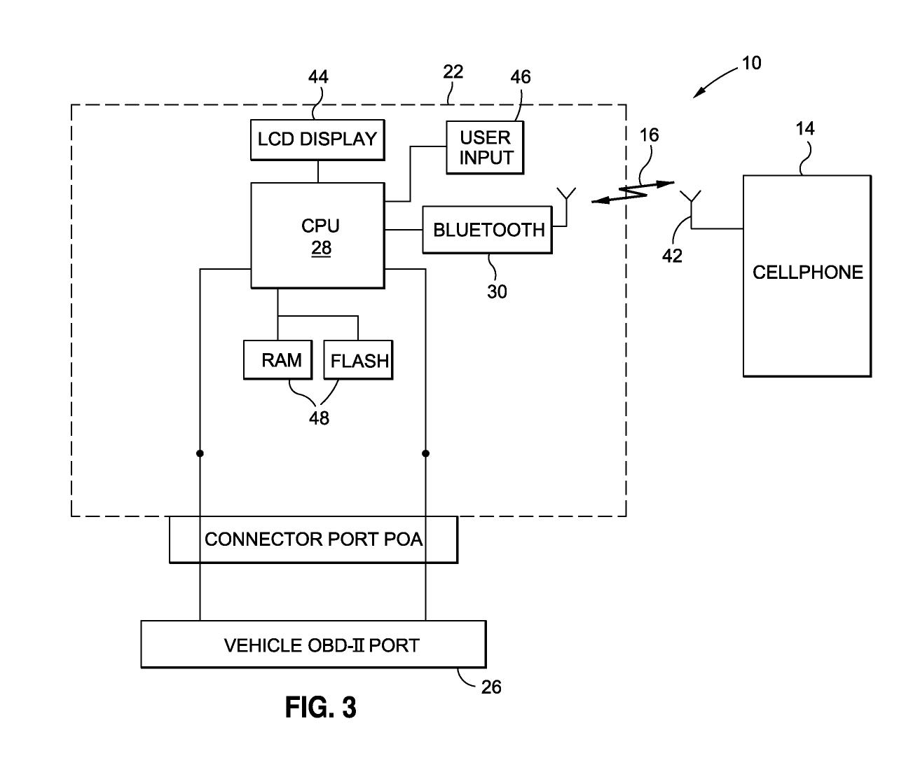

Referring now to FIG. 3, it may be seen that the indicator signal 16 may be transmitted by the wireless communication circuit 30 and received on the mobile communication device 14 by a second receiver 42. In one exemplary embodiment, the second receiver 42 is a Bluetooth receiver. However, it may be seen that any receiver capable of receiving a wireless signal that is of the type transmittable by a wireless communication circuit 30 may be utilized to receive the indicator signal 16.

In another exemplary embodiment, the monitoring device 22, which is connectable to a vehicle on-board computer 24 via a vehicle diagnostic port 26, has additional features. These additional features may include a monitoring device display 44 and a monitoring device user input module 46. It may thus be seen that such a monitoring device 22 may be configurable by a user. For example, the user may desire to alter the conditions under which an indicator signal 16 may be sent, or to provide additional information alongside or with the indicator signal 16 to the mobile communication device 14. For example, a user may use a number of monitoring devices 22 for use with a single mobile communication device 14, and may configure each monitoring device 22 to transmit additional vehicle information such as a monitoring device reference number, a VIN number or make and model information to the mobile communication device 14. Such configurations may be stored on a monitoring device memory 48.

This may be useful in, for example, a parking valet service in which a large number of unfamiliar vehicles 12 may be parked across a broad area. The valet may place a monitoring device 22 in a vehicle 12 after receiving possession of it from the customer, and upon parking and shutting off the engine of the vehicle 12, have the previously-configured monitoring device 22 send an indicator signal 16 containing descriptive vehicle information derived from the vehicle onboard computer 24, such as make and model information, to the mobile communication device 14, which may be the valet's cellular telephone or other device. Alternatively, make and model information may be derived using the cellular telephone, form a VIN number provided by the vehicle onboard computer. The vehicle information may then automatically be associated on the mobile communication device 14 with the vehicle location 34 for that vehicle 12. Thus, when the customer returns for their vehicle, they can provide the make and model information to the valet for rapid identification and retrieval of the vehicle 12. Alternatively, each monitoring device 22 may be configured to transmit a unique indicia, such as a number or letter that is associated with that monitoring device 22. Upon receiving possession of the vehicle 12 from the customer, the valet need only inform the customer of the indicia associated with the monitoring device 22 that will be placed in their vehicle, such as orally or by providing a physical ticket containing the indicia. When the vehicle 12 is parked and its engine shut off, the monitoring device 22 may transmit a signal representative of that particular indicia to the mobile communication device 14 alongside the indicator signal 16, allowing the mobile communication device 14 to associate the indicia with the vehicle location 34 determined for that vehicle 12. When the customer returns and provides the valet with the indicia, the valet may enter that indicia on the mobile communication device 14, which may cause a vehicle location query user input signal 36 corresponding to that indicia to be generated, resulting in the stored first location data 18 corresponding to the vehicle location 34 to be retrieved, causing the customer's vehicle location 34 to be displayed on the display module 32 of the mobile communication device 14. This may allow allowing for rapid and accurate identification and location of vehicles, especially in locations which may be unfamiliar to the valet. The valet may then retrieves the vehicle 12 and return it to the customer, pausing only to remove the monitoring device 22 from the vehicle 12 for use with a future customer.

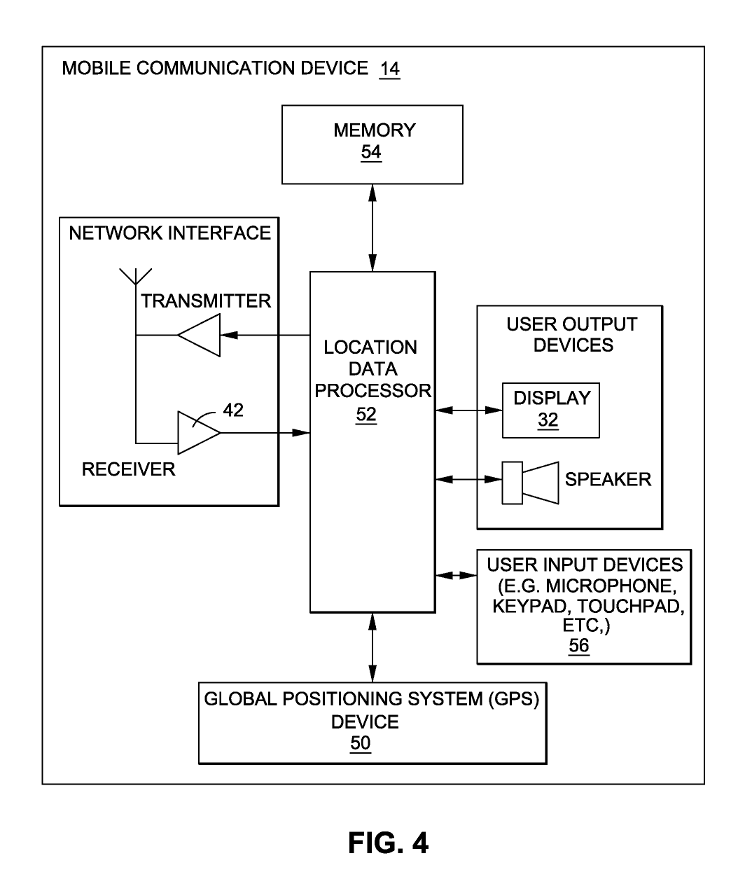

Referring now to FIG. 4, it may be seen that the mobile device 14 may include, in an exemplary embodiment, a first receiver 50 for receiving location data 18, a second receiver 42 for receiving the indicator signal 16, a display module 32 for conveying a representation of the vehicle location 34, a representation of the user location 38, and direction information 40 to the user, a location data processor 52, a memory 54, and an input module 56.

The first receiver 50 may be, in the exemplary embodiment, a GPS receiver for receiving GPS data. However, it may also be seen that the first receiver 50 may be any receiver capable of receiving location data 18 which may be utilized by the mobile communication device 14 to determine a location. Thus, the first receiver 50 may be, for example but without limitation, a radio receiver for triangulating or multilaterizing between radio towers of a cellular network, or for GSM localization based on signal strength, or a Wi-Fi receiver for a crowd-sourced Wi-Fi positioning system. It is also contemplated that in certain embodiments, the first receiver 50 may be the same physical component as the second receiver 42.

In one exemplary embodiment, the location data processor 52 is a CPU, ideally the CPU of a smart phone with a mobile operating system. However, it may be seen that the location data processor 52 may be any apparatus in communication with the first receiver 50, the second receiver 42, and the display module 32, and which is operative to receive and store location data 18 that is received on the first receiver 50 when the indicator signal 16 is received on the second receiver 42.

In that exemplary embodiment, the location data 18 corresponding to the vehicle location 34 and the user location 38 may be stored on a memory 54 for later retriever, such memory 54 being the memory 54 of in a smart phone with a mobile operating system. However, in other embodiments, the memory 54 may be, for example but without limitation, a volatile memory such as a CPU cache or random access memory, or a non-volatile memory such as solid state or flash memory or hard or optical drives.

The display module 32 is, in the exemplary embodiment, the graphical display of a smart phone with a mobile operating system. However, it may be seen that the display module 32 may be, in other embodiments, other forms of graphical display, or any means of conveying information to a user, such as through a numerical or textual display. The display module 32 may, in addition displaying representations of a vehicle location 34 and a user location 38, coordinate with a mapping module such as map software residing on a smartphone in order to create a more interactive and useful display for a user. Such a display may include, for example, a map containing directional information 40 for traveling between the user location 38 and the vehicle location 34

In some exemplary embodiments, the input module 56 is the input features of a smart phone with a mobile operating system. In some smart phones, the input module 56 may also be the display module 32 itself, for example, when the smart phone uses a capacitive interface or other form of touch screen. In other smart phones, alternatively or in addition to a touch screen, buttons or other form of user inputs may be provided as the an input module 56. It may be seen that in other embodiments of a mobile communication device, the input module 56 may vary widely in form and functionality, depending on the form of input itself. For example, many mobile communication devices are able to accept auditory inputs in addition to mechanical or electronic input.

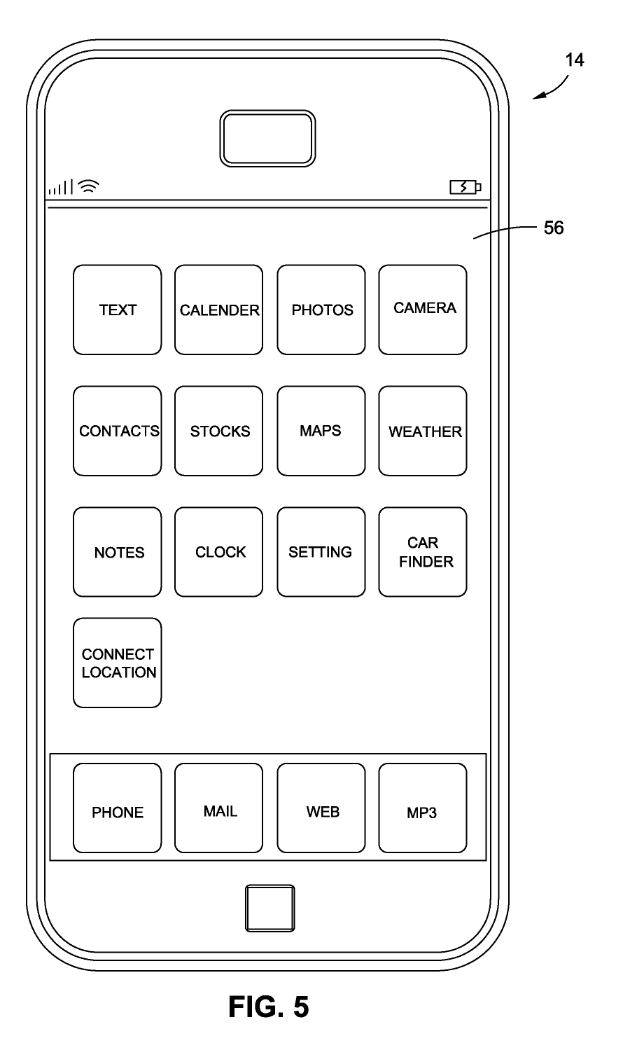

Referring now to FIG. 5, it may be seen that an input module 56 may be, in the illustrated exemplary embodiment, a touch-screen interface of a smart phone with a mobile operating system. In such an embodiment, the functions of the mobile communication device 14 may be performed at least in part by a software application running on the mobile operating system of the smart phone. Such a software application may run passively on a user's smart phone and activate upon receipt of the indicator signal 16 from the monitoring device 22, or may not activate, but merely store the vehicle location 34 upon receipt of the indicator signal 16. The vehicle location query user input signal 36 may thus be generated by the user commanding their smart phone to locate their vehicle, which in the exemplary embodiment may be by the user initializing a software application.

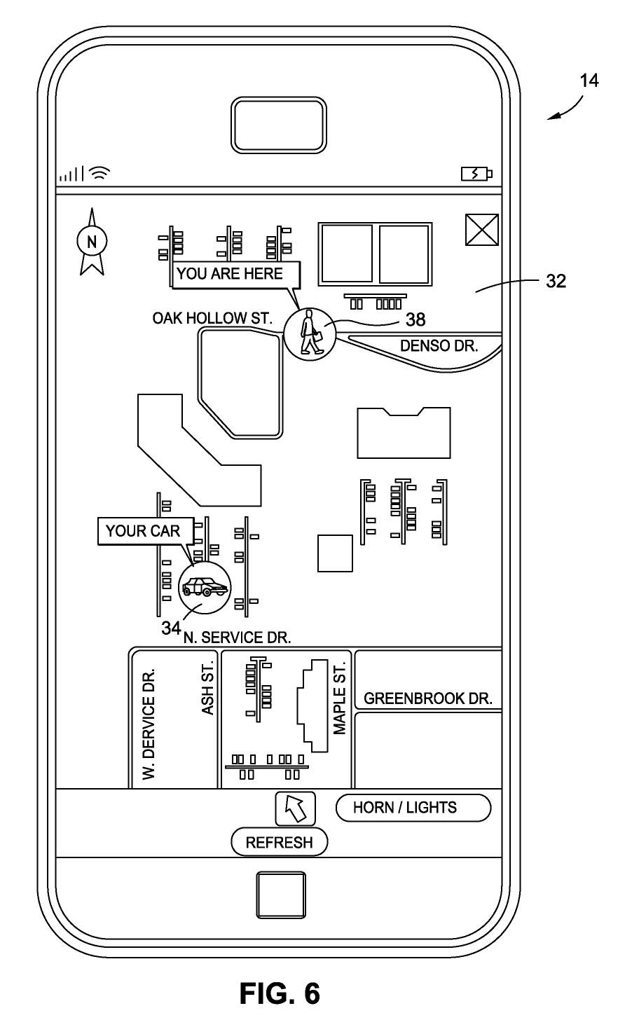

Referring now to FIG. 6, it may be seen that, in the exemplary embodiment, the display module 32 of the mobile communication device 14 may be the screen of a smart phone with a mobile operating system. The display module 32 may additionally interact with a mapping module, such as a map software residing on the smart phone to provide further detail beyond the user location 38 and the vehicle location 34. The interaction with the mapping module may also assist in deriving direction information 58. Many existing map software applications assist in deriving directional information between two or more inputted points, and it is contemplated that in a preferred embodiment, a software map application may be interfaced with by the system for vehicle location 10 through automatic input of the user location 38 and the vehicle location 34. The directional information may be conveyed to the user in forms such as, for example but without limitation, a line on a map or a series of instructions.

It may also be seen that the display module 32 may be configured to display representations of multiple stored vehicle locations 34. Further, it is envisioned that additional information may be displayed along with the representation of the vehicle location 34. Such information may include, for example but without limitation, a VIN number, make and model information, a vehicle status indication which may have been conveyed alongside with the indicator signal 16, or even an image of the vehicle 12. It may also be desirable for users to customize the appearance of the representation of the vehicle location 34, for example, with a photograph of the vehicle 12. As such, it is contemplated that the display module 32 may be communicative with the memory 54 to retrieve a stored vehicle image. Such a stored vehicle image may be, for example, captured with a camera integrated into the mobile communication device 14, such as cameras commonly found in cellular phones. It may be preferred that a system for vehicle location 10 application running on a smart phone mobile operating system may have an option to allow a user to take a photograph of their vehicle with the camera integrated in their smart phone and automatically have that image displayed proximal to the vehicle location 34 on the display module 32. In systems in which multiple vehicle locations 34 may be stored, multiple vehicle images may be displayed. Alternatively, the vehicle image may be used as a button on the input module 56 corresponding to the generation of the vehicle location query user input signal 36. The display module 32 may additionally periodically update the user location as the user location changes.

The above description is given by way of example, and not limitation. Given the above disclosure, one skilled in the art could devise variations that are within the scope and spirit of the invention disclosed herein, including various ways of configuring the mobile communication device 14 and the monitoring device 22. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A system for locating a stationary vehicle comprising:
a monitoring device operatively connectable to a vehicle, the monitoring device comprising:
a monitoring circuit for detecting when a vehicle engine is turned off, and for generating an indicator signal in response thereto; and
a wireless communication circuit for wirelessly transmitting the indicator signal;
a mobile communication device comprising:
a first receiver for receiving first location data corresponding to the location of the mobile communication device;
a second receiver for receiving the indicator signal from the monitoring device;
a location data processor in communication with the first receiver and the second receiver for receiving and storing location data, the location data processor being operative to receive and store first location data received on the first receiver when the indicator signal is received on the second receiver, the first location being representative of a first vehicle location; and
a display module in communication with the location data processor, the display module being operative to display a representation of the first vehicle location.

2. The system of claim 1, wherein the mobile communication device is a cellular telephone.

3. The system of claim 1, wherein the mobile communication device further comprises an input module in communication with the location data processor for receiving a vehicle location query user input signal, and wherein the display module displays the representation of the first vehicle position in response to the receipt of the vehicle location query user input signal on the location data processor.

4. The system of claim 3, wherein in response to receipt of the vehicle location query user input signal on the input module, the location data processor also receives and stores a second location data, the second location data being representative of a user location, when the vehicle location query user input signal is received.

5. The system of claim 4, wherein the display module is operative to display the stored second location data corresponding to the user location and the stored first location data corresponding to the first vehicle location.

6. The system of claim 5, wherein the display module is operative to display directional information for traveling between the user location and the first vehicle location.

7. The system of claim 1, wherein the monitoring circuit only generates the indicator signal when the monitoring circuit detects that the vehicle engine is turned off in combination the monitoring circuit detecting one or more additional vehicle status indications.

8. The system of claim 7, wherein the one or more additional vehicle status indications comprises a vehicle door status indication.

9. The system of claim 1, wherein the monitoring device receives vehicle identifying information from the vehicle, and communicates the vehicle identifying information to the mobile communication device.

10. The system of claim 9, wherein the vehicle identifying information comprises a vehicle identification number (VIN).

11. The system of claim 9, wherein the display module is operative to display a representation of the vehicle identifying information.

12. The system of claim 1, wherein the first receiver is a global positioning system (GPS) receiver, and the location data received on the first receiver is GPS data.

13. The system of claim 1, wherein the monitoring device wireless communication circuit is a local transmitter and the mobile communication device second receiver is a local receiver.

14. The system of claim 1, wherein the monitoring device includes a connector port, the connector port being operatively connectable to the vehicle via a vehicle diagnostic port.

15. An article of manufacture comprising a non-transitory computer readable medium readable by a data processing apparatus including a memory and an output device, the medium tangibly embodying one or more programs of instructions executable by the data processing apparatus to perform a method of locating a stationary vehicle, the method comprising the steps of:
receiving on the data processing apparatus an indicator signal generated in response to a user input shutting down a vehicle engine;
receiving first location data on the data processing apparatus, the first location data corresponding to a first vehicle location;
storing the first location data in a memory;
receiving a vehicle location query user input signal on the data processing apparatus;
retrieving the first location data from the memory in response to receipt of the vehicle location query user input signal; and
generating a representation of the first vehicle location on the output device.

16. The article of manufacture performing the method of claim 15, wherein the method further comprises the step of receiving a second location data in response to the vehicle location query user input signal, the second location data corresponding to a user location when the vehicle location query user input signal is received, and the generating step further comprises generating a representation of the user location on the output device;

17. The article of manufacture performing the method of claim 16, wherein the generating step further comprises generating on the output device directional information between the user location and the first vehicle location;

18. The article of manufacture performing the method of claim 16, wherein the first and second location data comprises GPS data.

19. The article of manufacture performing the method of claim 15, wherein the data processing apparatus comprises a cellular telephone.

20. The article of manufacture performing the method of claim 15, wherein the representation of the first vehicle location comprises a map.

21. The article of manufacture performing the method of claim 20, wherein the representation of the first vehicle location is generated on the output device via interfacing with a mapping module.

22. A method for locating a stationary vehicle with a mobile communications device having a memory, the method comprising the steps of:
receiving on the mobile communication device an indicator signal generated in response to a user input shutting down a vehicle engine;
substantially simultaneously with receiving the indicator signal, receiving on the mobile communication device a first location data, the first location data corresponding to a first vehicle location when the indicator signal was received;
storing on the memory of the mobile communication device the first location data;
receiving on the mobile communication device a vehicle location query user input signal;
retrieving the first location data from the memory in response to receipt of the vehicle location query user input signal; and
generating a representation of the first vehicle location on the mobile communication device.

23. The method of claim 22, wherein the method further comprises the step of receiving on the mobile communication device a second location data in response to the vehicle location query user input signal, the second location data corresponding to a user location when the vehicle location user input signal is received, and the generating step further comprises generating on the mobile communication device a representation of the user location;

24. The method claim 23, wherein the generating step further comprises generating on the mobile communication device directional information between the user location and the first vehicle location;

25. The method of claim 23, wherein the first location data and second location data comprises GPS data.

26. The method of claim 22, wherein the mobile communication device comprises a cellular telephone.

27. The method of claim 22, wherein the representation of the first vehicle location comprises a map.

28. The method of claim 27, wherein the representation of the first vehicle location is generated on the mobile communication device via interfacing with a mapping module.
